(19) United States
(12) Patent Application Publication
(10) Pub. No.: US 2016/0100523 A1
(43) Pub. Date: Apr. 14, 2016

(54) CONTOUR FOLLOWING MOWING MODULE

(71) Applicant: Autonomous Tractor Corporation, St. Michael, MN (US)

(72) Inventor: Terry Anderson, Spearfish, SD (US)

(21) Appl. No.: 14/878,934

(22) Filed: Oct. 8, 2015

Related U.S. Application Data
(60) Provisional application No. 62/062,608, filed on Oct. 10, 2014.

(51) Int. Cl. A01D 34/74; A01D 34/73; A01D 34/66

(52) U.S. Cl. CPC A01D 34/74; A01D 34/66; A01D 34/73; A01D 34/661; A01D 2101/00

(57) ABSTRACT

A contour following mowing apparatus and associated methods are described that include a mower platform. A rotational coupling can be configured to couple to a motor, wherein the rotational coupling includes a fixed portion and a rotatable portion, and the fixed portion of the rotational coupling is attached to the mower platform. A shaft can be operably coupled to the rotatable portion of the rotational coupling, wherein the rotational coupling is configured to rotate the shaft, and the shaft is configured to translate axially from a first location to a second location with respect to the rotational coupling. A blade can be coupled to the shaft and positioned outwardly from the shaft, wherein the blade includes a cutting edge. In one example, the elements above can be included in a mowing module that is coupled to the mower platform with at least one fastener.

### CLAIM OF PRIORITY

This application claims the benefit of priority under 35 U.S.C. §119(e) to U.S. Provisional Patent Application Ser. No. 62/062,608, filed on Oct. 10, 2014, the benefit of priority of which is claimed hereby, and which is incorporated by reference herein in its entirety.

### TECHNICAL FIELD

Various embodiments described herein relate to apparatus, systems, and methods associated with trimming plants, foliage, or brush.

### BACKGROUND

Mowing devices, such as mowing devices used in agricultural applications, are typically attached to an agricultural vehicle or ground working device. One or more mowing devices are commonly included on a mowing rig in order to increase the cutting area of the mowing device. Typically, Mowing blades are coupled to a mowing rig in a fixed relation and cannot adjust to changing terrain. Some mowing devices are hingedly coupled to a mowing rig; however, the distance between mower blades changes in response to the rotation of the mowing devices with respect to one another. This can cause gaps in mowing coverage, or require large overlap between adjacent mowing blades paths, thus reducing mowing coverage of each mowing device. Many mowing devices include a linkage or a system of linkages that couple one or more mower blades to a central power source, for instance a motor, to rotate the mower blades. When one of these linkages fails, the entire mowing apparatus can be inoperable. Improved mowing devices and methods are desired to provide enhanced reliability, maintainability, and adaptability to changing terrain.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic view of one example of a mowing platform coupled with a plurality of mowing modules.

FIG. 2 is a view of one example of a plurality of mowing modules coupled to a mowing platform.

FIG. 3 is a cross sectional view of one example of the mowing module of FIG. 2 in the extended state.

FIG. 4 is a cross sectional view of one example of the mowing module of FIG. 3 in the partially collapsed state.

FIG. 5 is a cross sectional view of one example of the mowing module viewed perpendicular to the axis of the shaft and cut through the location of the engagement of the rotational coupling to the shaft.

FIG. 6 is a block diagram of one example of a method of making the mowing apparatus.

### DETAILED DESCRIPTION

Described herein are various configurations of devices and methods of a mowing apparatus, such as a contour following mowing module. The following examples and drawings illustrate the invention to enable those skilled in the art to practice the subject matter described in the following detailed description. Portions and features of some examples may be included in, or substituted for, those of other examples.

The present inventors have recognized, among other things, that the problem of trimming grass, brush, crops, foliage, or the like located on an uneven landscape can be solved by the present subject matter. A mowing apparatus can include blades that adjust to follow the contour of a landscape in order to achieve a more uniform resultant height of the trimming subject (e.g., grass, brush, crops, foliage, or the like). For instance, the blades can translate along the axis of their rotation (e.g., perpendicular to the plane in which the blades rotate) to maintain a desired distance above the landscape. Stated another way, the distance between the blades and a mower platform or a motor can adjust so the blades to follow the contour of the landscape.

In one example, the mowing apparatus can be attached to an agricultural vehicle or ground working device, such as a tractor or riding lawn mower. The mowing apparatus can include a mowing platform, a rotational coupling, a shaft, a mower disk, and at least one blade. The mowing platform can be coupled to the agricultural vehicle or ground working device, for example, with a hitch. The agricultural vehicle moves the mowing apparatus along a landscape and over the trimming subject. The blades of the mowing apparatus are coupled to the shaft. The blades include an edge that cuts the trimming subject when the shaft is rotated at a cutting velocity. The shaft is coupled to a motor by the rotational coupling, and the rotational coupling is configured to apply torque to the shaft as well as translate along the shaft to allow the rotational coupling to be positioned at a first shaft end, second shaft end, or any location therebetween. In one example, the shaft can include splines, such as grooves in the shaft. The rotational coupling can include lugs that engage with the splines of the shaft. The lugs can be configured to transfer torque from the motor to the shaft and to slide along the shaft between a first end and a second end of the shaft. In other words, the rotational coupling is coupled to the motor to rotate the shaft and permits the shaft to translate along its rotational axis with respect to the rotational coupling.

In one example, the blades are coupled to the mower disk and the mower disk is coupled to the shaft. The mower disk can include a semi-spherical surface for engaging with the landscape. The mower disk can include an optional follower plate for engaging with the landscape. The follower plate can be configured to include a low friction material for engaging with and sliding along the landscape. The shaft can translate with respect to the rotational coupling in response to changes in distance between the mower disk or follower plate (engaged with the landscape) and the mower platform.

In one example, at least the motor, rotational coupling, shaft, blade, and other items discussed herein can be combined into a mowing module. One or more modules can be coupled to a mower platform with a mount. These modules can be quickly replaced if a module is not operating properly. Additionally, the mowing apparatus can continue to operate if one or more of the mowing modules is not functioning properly. The ability to expand the mowing area of the mowing apparatus through the addition of more mowing modules is a further benefit to the modular configuration.

In one example, the at least one mowing module does not include a dedicated motor, but is powered by a shared motor, such as a power-take-off (PTO) of the agricultural vehicle, an electrical motor, hydraulic motor, or internal combustion engine operationally coupled to each of the mowing modules. The shared power source can be included in the mowing apparatus and coupled to the mower platform. Depending on the type of power source, the mowing modules can be coupled to the power source by electrical lines, hydraulic lines, mechanical linkages, gears, chains or the like. The weight and cost of the mowing apparatus can be reduced by employing a shared power source rather than including a dedicated motor in each mowing apparatus.

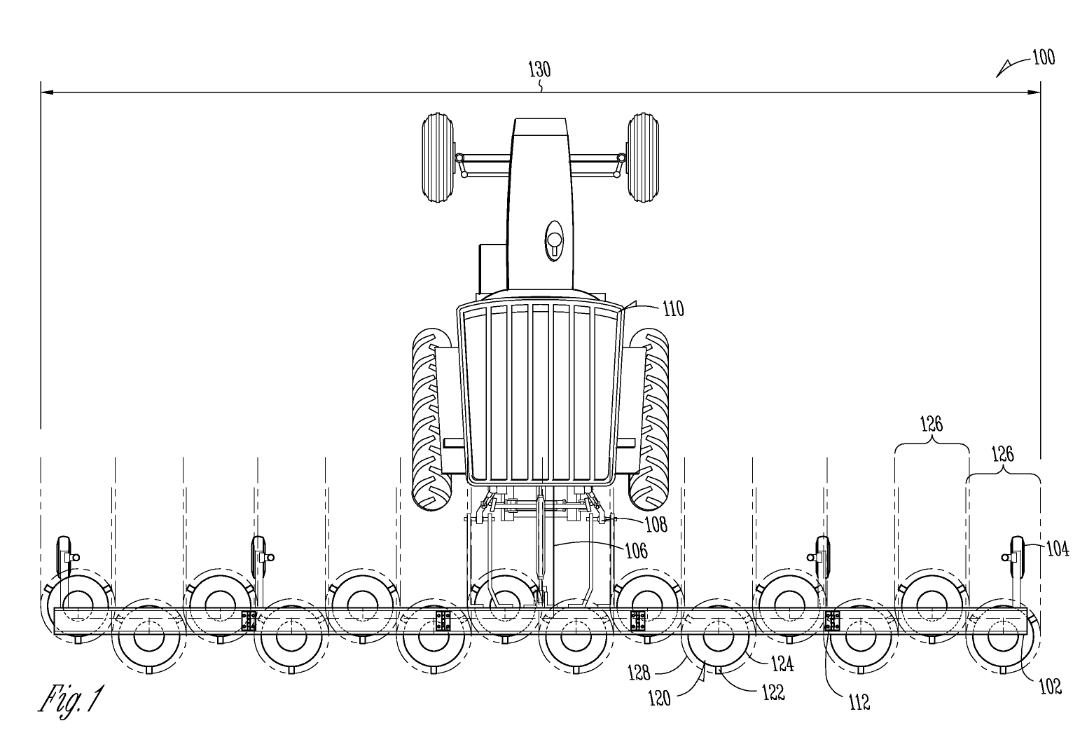

FIG. 1 shows an example of a schematic view of a mowing apparatus, such as a contour following mowing apparatus 100. The mowing apparatus 100 is coupled to an agricultural vehicle 110. The mowing apparatus includes at least one mowing module 120. The mowing module 120 (hereinafter “module 120”) is coupled to a mower platform 102 (referred to as “platform” in this disclosure) with a hitch 108. As shown by way of an example in FIG. 1, the platform 102 includes at least one ground engaging wheel 104. The ground engaging wheel 104 at least partially supports the platform 102 on the landscape. For instance, the platform 102 is coupled to the agricultural vehicle 110 and rests on the landscape with at least one ground engaging wheel 104. The platform 102 pivots at the axis of the ground engaging wheel 104, and the hitch 108 of the agricultural vehicle 110 dictates the orientation of the platform 102 with respect to the landscape. In one example, the platform 102 is supported entirely by the hitch 108, and no ground engaging wheels 104 are included along the platform 102. The hitch 108 can swivel in one or more directions to allow the platform 102 to turn with respect to the agricultural vehicle 110 or tilt with respect to the agricultural vehicle (e.g., when the agricultural vehicle 110 is on a sloped landscape).

The platform 102 includes one or more elongate members, such as tubes, beams, trusses, sheet, or the like. In one example, the platform 102 includes a single elongate member. Alternatively, in one example, the platform 102 can include a plurality of elongate members. The elongate members are coupled to form the platform 102. The elongate members are coupled by means including, but not limited to welding, a hinged coupling, fastening, slidable coupling (e.g., telescoping elongate members), or the like. In one example, the elongate members are coupled with a hinge 112 that facilitates folding of the platform 102. Folding the platform 102 reduces that amount of storage space required for the mowing apparatus 100. In one example, the platform 102 can fold to reduce the overall mowing width 130 of the mowing apparatus 100. Reducing the overall mowing width 130 is advantageous if the landscape is positioned between obstacles and the fully extended platform 102 cannot navigate between the obstacles. The platform 102 can be fabricated in part, or as a whole, with materials including, but not limited to, steel, aluminum, fiberglass, polymer, or the like.

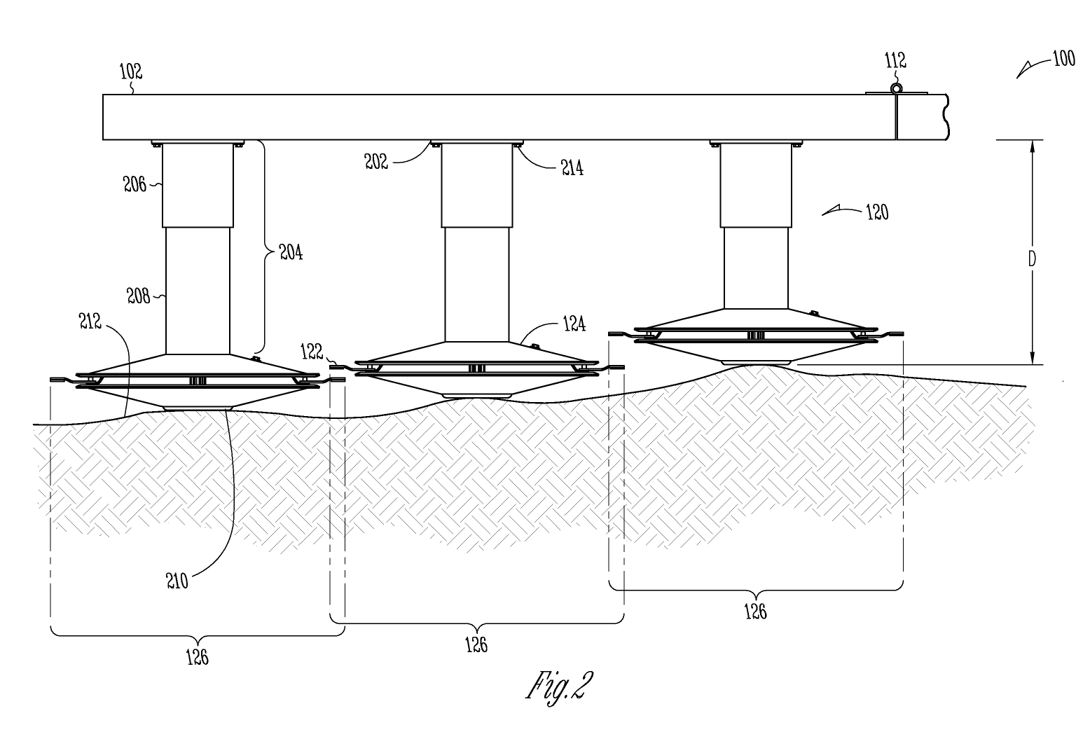

The mowing apparatus 100 shown in FIG. 1 includes a mowing platform 102 with a plurality of mowing modules 120 coupled thereto. Each mowing module 120 (as shown in FIGS. 2-5 and further described herein) includes at least one blade 122, a shaft, and a rotational coupling. The blade 122 is coupled to the shaft and rotates along with the shaft. The shaft is coupled to a motor by a rotational coupling. In one example, the mowing module includes a mower disk 124. The at least one blade 122 is coupled to the mower disk 124 and the mower disk 124 is coupled to the shaft.

As shown in FIG. 1, the modules 120 are located along the platform 102 in a staggered arrangement. The one or more blades 122 of each module 120 cut a path 126 along the mowing subject as the mowing apparatus 100 travels along the landscape. The width of the path 126 is the distance across the diameter of rotation of the cutting blade 122. In one example, the modules 120 are staggered so the cutting path 126 of each module 120 overlaps in order to minimize or eliminate gaps between the cutting paths 126 of each module 120. An advantage of the staggered arrangement is the reduction or elimination of the need to synchronize the rotation of adjacent blades 122 in order to achieve overlap between cutting paths 126 and avoid collision between the blades 122 of adjacent modules 120. For instance, the rotational path 128 of the blade 122 (with respect to the platform 102) included in one module 120 does not overlap with the rotational path 128 of the blade 122 included in another module 120. The overall mowing width 130 includes the combined width of the cutting paths 126 (minus any overlap between cutting paths 126) perpendicular to the direction of travel of the mowing apparatus 100. For instance, the overall mowing width 130 is less than the sum of each cutting path 126.

In one example, each module 120 includes a motor (as shown in FIG. 2 and described herein). The motor is coupled to the shaft by the rotational coupling. In another example, the at least one module 120 can be powered by a shared power source, such as a power-take-off (PTO) of the agricultural vehicle 110, an electrical motor, hydraulic motor, or internal combustion engine operationally coupled to each of the modules 120. The shared motor can be included in the mowing apparatus 100 and coupled to the mower platform 102. Depending on the type of motor, the module 120 can be coupled to the motor by at least one transmission coupling 106 including, but not limited to, electrical lines, hydraulic lines, mechanical linkages, gears, chains or the like. The motor rotates the blade 122 by way of the rotational coupling and the shaft and provides sufficient kinetic energy to cut the trimming subject with the blade 122.

Where each module 120 includes a motor, the transmission couplings 106 communicate control signals to the modules 120. For instance, the transmission couplings 106 include signal wire that facilitates the communication of operator commands from an input device to a controller (e.g., variable frequency drive) included within the module 120. The controller is configured to deliver operating parameters to the motor, such as controlling the speed of the motor or stopping motor rotation.

In one example, the mowing apparatus 100 includes a shared motor. Accordingly, the modules 120 are coupled to the shared motor by at least one transmission coupling 106. The shared motor rotates the rotational coupling of the module 120 through mechanical linkages, axels, gears, chains, or the like. The rotational coupling can also be rotated by hydraulic pressure provided by the shared motor. For instance, the hydraulic pressure rotates a hydraulic turbine motor attached to the rotational coupling.

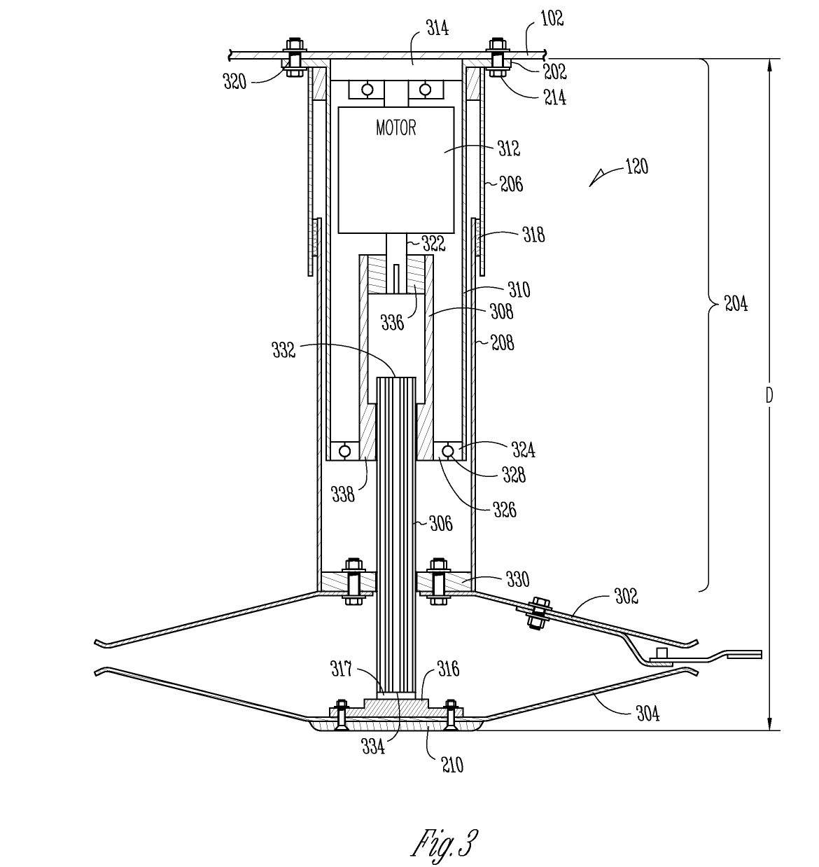

FIG. 2 shows one example of a plurality of mowing modules 120 (e.g., three as shown) coupled to the platform 102. In the example shown in FIG. 2, each module 120 is coupled to the platform 102 with a mount 202. For instance, at least one fastener 214 couples the mount 202 to the platform 102. The mount 202 can be included into a module frame (as shown in FIG. 3 and described herein). Stated another way, the mount 202 and frame are fabricated as a single component. In one example, the mount 202 is coupled to the frame. In this example, the mount 202 includes a plate or bracket coupled to the module 120 (or frame) with at least one fastener. As referred to in this specification, a fastener (including the fastener 214) includes, but is not limited to, a screw, bolt, rivet, pin, adhesive, weld, strap, tie, or the like. The mount 202 is shaped to mate with the platform 102. For instance, the mount 202 includes a surface that substantially matches the portion of the platform 102 that the module 120 is coupled to. In one example, the platform 102 includes a bracket or mounting holes for coupling the mount 202 thereto with at least one fastener 214.

In the example shown in FIG. 2, each module 120 includes a mower disk 124. The mower disk 124 includes at least one blade 122 coupled to the mower disk 124 and positioned outwardly from the perimeter of the mower disk 124. In one example, the mower disk 124 includes three, six, or other number of blades 122 symmetrically positioned around the perimeter of the mower disk 124. As shown in FIG. 2, one mower disk 124 is positioned at a maximum distance D from the platform 102. Each of the mower disks 124 translate toward or away from the platform 102 along the center axis of the disk 124. In one example, one mower disk 124 shown in FIG. 2 is positioned at a minimum distance D from the platform 102. Each mower disk 124 can translate to, or be positioned at, the maximum distance D from the platform 102, the minimum distance D from the platform 102, or any distance D therebetween.

In one example, the at least one blade 122 is coupled directly to the shaft (as shown in FIG. 3 and described herein). The shaft can include three, six, or other number of blades 122 symmetrically positioned around the diameter of the shaft. The shaft is configured to translate toward or away from the platform 102 along the center axis of the shaft. In one example, the shaft is positioned at a minimum distance D from the platform 102. The shaft can translate to, or be positioned at, the maximum distance D from the platform 102, the minimum distance D from the platform 102, or any distance D therebetween.

The mower disk 124 engages with the landscape 212. For instance, the mower disk 124 is in contact with the landscape. In one example, the mower disk 124 includes a follower plate 210. As shown in FIG. 2, the follower plate 210 is coupled to the bottom of the mower disk 124 with one or more fasteners. The follower plate 210 engages with the landscape 212. The material of the follower plate 210 includes, but is not limited to, steel, aluminum, polymer, composite, or other materials. The follower plate 210 provides several advantages to the mowing apparatus 100. In one example, the follower plate 210 protects the disk 124 from damage, for instance, as a result of a collision between the disk 124 and an obstruction (e.g., a rock) on the landscape 212. In one example, the material of the follower plate 210 includes a low friction material (e.g., Polyoxymethylene) that minimizes friction resulting from engagement between the disk 124 and the landscape 212. The follower plate 210 is easily and inexpensively replaced if damaged. For instance, removal of one or more fasteners decouples the follower plate 210 from the disk 124. A new follower plate 210 can be attached to the disk 124 with one or more fasteners. In one example, the follower plate 210 includes an inexpensive material and fabrication. In one example, the follower plate 210 is coupled to the shaft, such as at the end of the shaft (e.g., second shaft end shown in FIG. 3 and described herein) at the furthest distance D from the platform 102.

Force is exerted on the follower plate 210 when the distance D between the platform 102 and the follower plate 210 decreases, such as when a localized feature of the landscape 212 is raised above the surrounding landscape 212. For instance, force is applied to the follower plate 210 when the D is less than the maximum distance D. In one example, force is applied to the follower plate 210 when the distance D is less than the distance between the platform 102 and the portion of the ground engaging wheel 104 that contacts the landscape 212.

As shown in one example in FIG. 2, the module 120 includes a shield 204. The shield 204 includes at least one segment coupled to the frame, mount 202, or disk 124. Each segment translates with respect to the other segments. In one example, the segment includes at least one large shield segment 206 and at least one small shield segment 208. The segments are sized and shaped such that the small shield segment 208 fits within the immediately adjacent large shield segment 206. In other words, the large shield segment 206 and small shield segment 208 nest together to form a shield 204 that telescopes and includes an adjustable length.

These modules 120 can be quickly replaced if a module 120 is not operating properly. Additionally, the mowing apparatus 100 can continue to operate, if one or more of the modules 120 are not functioning properly. The ability to expand the overall mowing width 130 of the mowing apparatus 100 through the addition of more modules 120 is a further benefit to the modular configuration.

FIG. 3 shows one example of a cross section view of the module 120. As previously mentioned, the module 120 includes, the follower plate 210, the disk 124 (including an upper disk 302 and a lower disk 304), the blade 122, the small shield segment 208, the large shield segment 206, the shaft 306, the rotational coupling 308, the module frame 310, the motor 312, the controller 314, the mount 202, and the fasteners 214. Additionally, the example shown in FIG. 3 also includes a disk bracket 316 and a shield bushing 318.

In one example, the module 120 is coupled to the platform 102 with the mount 202. As previously described, fasteners 214 attach the mount 202 to the platform 202. As shown in FIG. 3, the frame 310 includes the mount 202, such as the mount 202 and the frame 310 are one component. In one example, the mount 202 and the frame 310 are individual components, and the mount 202 is coupled to the frame 310 with at least one fastener 214.

As shown by way of example in FIG. 3, the frame 310 includes a cylindrical shape. The portion of the frame 310 that couples to the platform 102 includes a flange (e.g., the mount 202) positioned perpendicular to the cylindrical portion. In one example, the flange is positioned in any configuration to mate with the platform 210. The materials of one or more of the frame 310 or mount 202 include, but are not limited to, steel, aluminum, fiberglass, polymer, or the like. In one example, the flange includes at least one passage 320 with at least one fastener 214 positioned therethrough for coupling the frame 310 to the platform 102. Other components included in the module 120 are coupled to the frame 310. For instance, one advantage of the frame 310 is to couple or decouple the entire module 120 from the platform 210 easily by way of the fasteners 214.

As previously discussed in one example, the module 120 includes a motor 312. For instance, the motor 312 is coupled to the frame 310 with at least one fastener. A person of ordinary skill in the art will appreciate that the motor 312 can include, but is not limited to, an electrical motor, hydraulic motor, or internal combustion engine. In one example, the motor 312 includes sufficient power to operate the mowing apparatus 100, such as a five, ten, fifteen, twenty-five, or other horsepower motor. The motor 312 includes a motor shaft 322 that rotates in response to a command received from the controller 314. In one example, the controller 314 can include a variable frequency drive or other type of motor controller. The controller 314 delivers operating parameters to the motor 312, such as dictating the speed of the motor shaft 322 rotation or stopping the rotation of the motor shaft 322.

The motor shaft 322 is coupled to a rotational coupling 308. The rotational coupling 308 includes a fixed portion 324 and a rotatable portion 326. The fixed portion 324 of the rotational coupling 308 is attached to the frame 310. The rotatable portion 326 of the rotational coupling 308 is coupled to a first shaft end 332. For instance, the rotatable portion 326 includes a cylinder shape, such as a socket, with an open socket end 338 and a closed socket end 336. The fixed portion 324 of the rotatable coupling 308 is coupled to the frame 310 by one or more of a fastener, weld, adhesive, press-fit, or the like. The rotatable portion 326 is coupled to the motor shaft 322 by one or more of the same means. In one example, the rotational coupling 308 includes a rotational bearing. For instance, the fixed portion 324 of the rotational coupling 308 includes an outer race of the rotational bearing. The rotatable portion 326 of the rotational coupling 308 includes the inner race of the rotational bearing. A ball bearing 328 reduces friction between the rotatable portion 326 (e.g., inner race) and the fixed portion 324 (e.g., outer race).

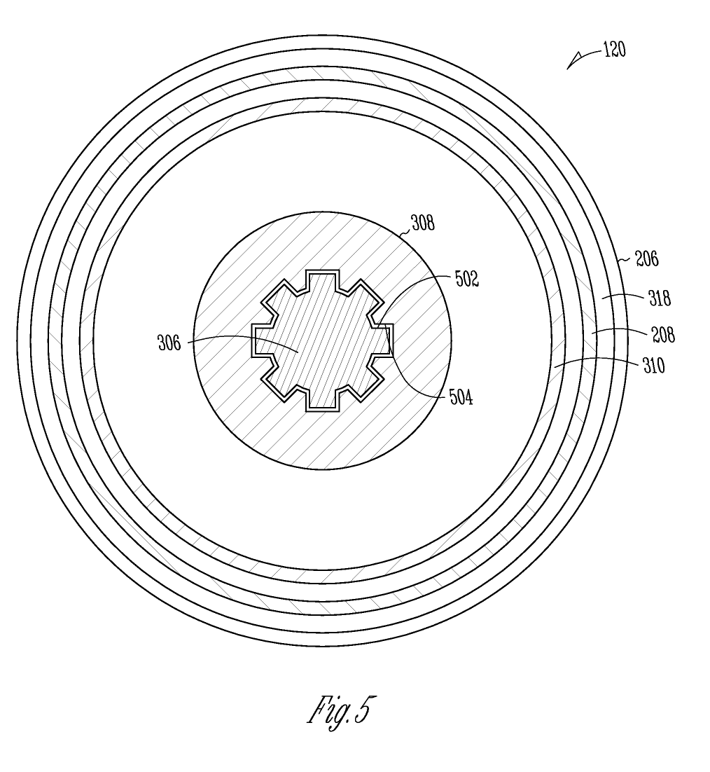

The rotatable portion 326 includes one or more engagement features configured to rotate the shaft 306. For instance, the engagement feature includes a lug located on the inside (e.g., inside diameter of the rotatable portion 326) of the rotational coupling 308. The shaft 306 includes at least one spline (e.g., grooves, channels, ribs, or the like) along the length of the shaft 306. The lug (as shown in FIG. 5 and described herein) on the rotational coupling 308 engages with at least one spline on the shaft 306 such that the rotational coupling 308 is configured to rotate the shaft 306. In one example, rotation of the motor shaft 322 results in rotation of the rotational coupling 308 and in turn the shaft 306.

The rotational coupling 308 is configured to translate with respect to the shaft 306. For instance, the rotational coupling 308 is operationally coupled (i.e., can translate along and transfer torque) at the first shaft end 322, the second shaft end 334, or at any location therebetween. Stated another way, the lugs of the rotational coupling 308 engage with the splines of the shaft 306 at a location at which the rotational coupling 308 is positioned along the shaft 306. The rotational coupling 308 is sized and shaped to receive the shaft 306. In one example shown in FIG. 3, the rotational coupling 308 includes a socket shape as previously described. The shaft 306 is coupled within the rotational coupling 308. The shaft 306 is inserted in the open socket end 338 and the socket includes a closed socket end 336 located on the end of the rotatable coupling 308 closest to the motor shaft 322. In an extended position, the shaft 306 is partially inserted in the rotational coupling 308. Clearance exists between the first shaft end 322 and the closed socket end 336 of the rotational coupling 308. In a collapsed position, the first shaft end 332 is located at the closed socket end 336. The material of one or more of the rotational coupling 308 or the shaft 306 includes, but is not limited to, steel, aluminum, polymer, composite, ceramic, or the like.

The second shaft end 334 is coupled to the mower disk 124. In one example, the mower disk 124 includes an upper disk 302 and a lower disk 304. The lower disk 304 and upper disk 302 include a semi-curved shape such that the perimeter of the disk 124 is thinner than at the center. Stated another way, the lower disk 304 and upper disk 302 are each formed from a circular piece of sheet metal and each includes a curvature, angle, or combination thereof. The shaft 306 is located at the center of each disk 124 where each disk is spaced apart at a first distance. The lower disk 304 and the upper disk 302 are spaced apart less than the first distance at the perimeter of the disk 124 than at the center due to the curvature or angle of the lower disk 304 or upper disk 302. A lower disk bracket 316 rotationally couples the second shaft end 334 to the lower disk 304 with at least one fastener. In the example shown in FIG. 3, the lower disk bracket 316 includes a bracket bearing 317 (e.g., a wheel bearing) such that the bracket bearing 317 couples the lower disk 304 to the shaft 306 and the lower disk 304 is free to rotate with respect to the shaft 306.

The mower disk 124 is coupled to the shaft 306, such that the mower disk 124 rotates with the shaft 306. As previously described, the mower disk 124 includes at least one blade 122. The rotation of the shaft 306 (and also the disk 124) by the motor 312 rotates the one or more blades 122. The rotation of the blade propels the cutting edge of the blade 122 at a sufficient velocity to cut the trimming subject.

In one example, the upper disk 302 rotates and the lower disk 304 is stationary. The shaft 306 is coupled to the upper disk 302 by the upper disk bracket 330. For instance, the upper disk 302 rotates when the shaft 306 is rotating. The at least one blade 122 is coupled to the upper disk 302. In one example, the upper disk bracket 330 couples the shield 204 (e.g., small segment 208) to the upper disk 302. The small shield segment 208 rotates with respect to the large shield segment 206. In one example, the small shield segment 208 includes at least one material blade for cutting wire or other objects that contact the small shield segment 208. In one example, the lower disk 304 does not rotate with the shaft 306. One advantage to this configuration is that the lower disk 304 travels along the landscape 212 with reduced rotational force against the landscape 212. Reduced rotational force on the landscape 212 is less damaging to the trimming subject.

The module 120 can include at least one of a spring element or a damper element. One or more of the spring element or damper element is coupled to the platform 102 (e.g., via the frame 310) at a first end of the spring element or damper element. A second end of the spring element or damper element is coupled to the second shaft end 334 (e.g., via the disk 124 or the lower disk bracket 316).

The spring element exerts force on the second shaft end 334 in order to translate the shaft 306 to a maximum amount of extension. The spring element provides the advantage of maintaining the position of the follower plate 210 on the landscape 212.

The damper element resists the translation of the shaft 306. The damper element includes a hydraulic cylinder, pneumatic cylinder, dashpot, or other type of damper element. The damper element reduces the translation speed of the shaft 306. One advantage of a module 120 including the damper is reduced vibration from transient extension and refraction of the shaft 306. Another advantage is a more uniform cutting height of the trimming subject.

As shown in FIG. 3, the blade 122 includes a base and a distal end. The base portion is coupled to the shaft 306 and the distal portion of the blade 122 is positioned outwardly from the center axis of the shaft 306 and includes a cutting edge. In one example, the base of the blade 122 is configured to couple to the shaft 306 with a fastener, a weld, an adhesive, or the like.

In one example, the blade 122 is coupled to the disk 124. For instance, the blade 122 is rotatably coupled to the disk 124. The blade 122 is aligned in a position extended outwardly from the shaft 306 by centrifugal force. The stress on the blade 122 is mitigated by the rotatable blade coupling, such as if the blade 122 collides with an object (e.g., a rock), the blade 122 pivots out of the way of the obstruction.

In the example shown in FIG. 3, the small shield segment 208 of the shield 204 is partially located inside of the large shield segment 206. As the one or more blades 122 translate toward the platform 102 (e.g., when the distance D decreases in response to an uneven landscape 212) an increased portion of the small shield segment 208 translates within the large shield segment 206. The segments of the shield 204 (e.g., the large segment 206 and small segment 208) block foreign objects from contact with at least one of the shaft 306, rotatable coupling 308, motor 312, or other components of the module 120.

A shield bushing 318, such as a felt strip is positioned between the segments (e.g., large segment 206 and small segment 208) of the shield 204. In one example, the shield busing 318 is located along the internal circumference of the large segment 206. The shield bushing 318 provides a bearing surface for the translation of the small segment 208 with respect to the large segment 206, such as to reduce friction between the small segment 208 and large segment 206. In one example, the shield bushing 318 fills the gap between the different diameters of the small segment 208 and the large segment 206. For instance, the shield busing 318 seals out debris and foreign objects from contact with at least one of the shaft 306, rotatable coupling 308, motor 312, or other components of the module 120.

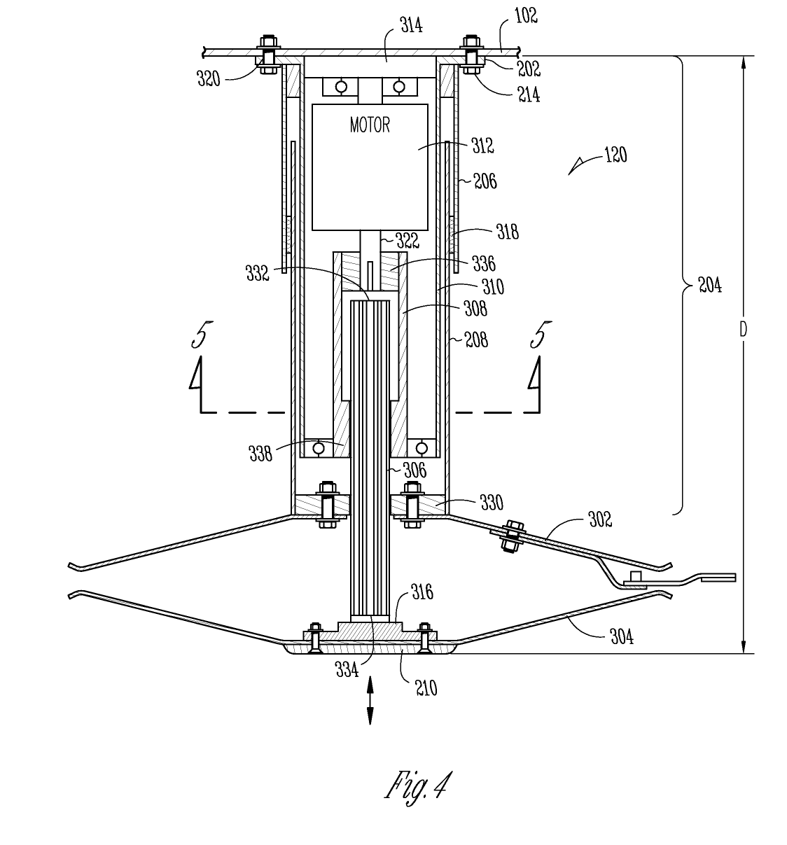

FIG. 4 shows one example of a cross section of the module 120 with the rotational coupling 308 positioned between the first shaft end 332 and the second shaft end 334 (e.g., a collapsed state of the module 120). As shown in FIG. 4, the first shaft end 332 is positioned near the closed socket end 336 of the rotational coupling 308 as a result of force applied to the follower plate 210. The rotational coupling 308 is configured to transfer torque to the shaft 306 as shown in FIG. 4. The distance D between the follower plate 210 and the platform 102 is reduced due to the location of the landscape 212 with respect to the platform 102 at the location beneath the follower plate 210. Accordingly, the small shield segment 208 is located within the large shield segment 206 such that the shield 204 includes a length that is reduced compared to the maximum shield length. In the collapsed configuration, the shield 204 maintains the function of preventing debris and foreign objects from contacting the shaft 306, rotatable coupling 308, motor 312, or other components of the module 120. The shield bushing 318 remains located between the small shield segment 208 and the large shield segment 206 such that it also maintains these functions.

FIG. 5 shows one example of a cross section of the rotational coupling 308 engaged with the shaft 306 viewed from an orientation perpendicular to the axis of the shaft 306 at a location between the open socket end 338 and the closed socket end 336 of the rotational coupling 308. The shield 204 (e.g., the large shield segment 206 or small shield segment 208) surrounds the rotational coupling 308 and the shaft 306.

The shaft 306 includes at least one spline 502 located along the length of the shaft 306. In one example, a plurality of splines 502 are symmetrically positioned around the axis of the shaft 306. As shown in FIG. 5, the spline 502 includes rectangular channels within the shaft 306. In one example, the spline 502 includes a raised feature along the shaft 306. The spline 502 can include features, such as semi-circular, triangular, trapezoidal, or other cross sectional shapes either raised from or cut into the surface of the shaft 306.

The rotational coupling 308 includes at least one lug 504 that engages with the spline 502 of the shaft 306. Torque can be applied to the rotational coupling 308 (e.g., from the motor 312) and the torque is transferred to the shaft 306 by way of the at least one lug 504 engaging with the at least one spline 502. The cross sectional shape of the lug 504 is configured to engage and apply torque to the spline 502. The lug 504 can translate along the spline 502 from a first shaft end 332 to a second shaft end 334. In one example, a plurality of lugs 504 are symmetrically positioned within the inner diameter of the rotational coupling 308. The interface between the spline 502 and the lug 504 includes sufficient clearance to avoid binding between the shaft 306 and the rotational coupling 308. At least one of the spline 502, lug 504, or combination thereof includes a material such as steel, aluminum, polymer, or the like. In one example the material is a hardened material (e.g., induction hardened steel) to reduce the wear from the engagement of the spline 502 and lug 504.

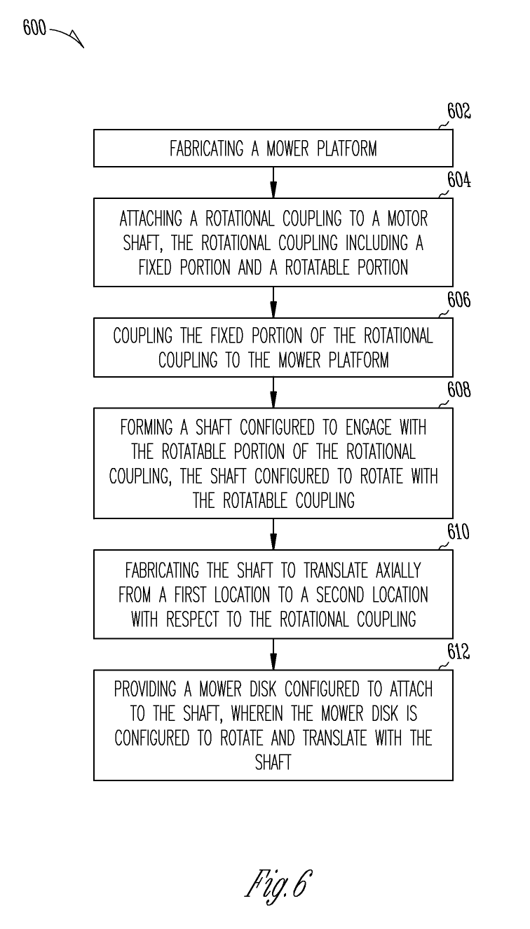

FIG. 6 shows a block diagram of one example of a method of making the mowing apparatus 100.

At 602, a mower platform 102 is fabricated. The platform 102 includes one or more elongate members, such as tubes, beams, trusses, sheet, or the like. In one example, the platform 102 includes a single elongate member. Alternatively, in one example, the platform 102 can include a plurality of elongate members. The elongate members are coupled by a manner including, but not limited to, welding, a hinged coupling, fastening, a slidable coupling (e.g., telescoping elongate members), or the like. In one example, the coupling of elongate members includes a hinge 112 that facilitates the folding of the platform 102. Folding the platform 102 reduces that amount of storage space required for the mowing apparatus 100. The platform 102 can be fabricated in part, or as a whole, with materials including, but not limited to, steel, aluminum, fiberglass, polymer, or the like. In one example, at least one ground engaging wheel 104 can be coupled to the mower platform 102. The ground engaging wheel 104 at least partially supports the platform 102 on the landscape 212. In one example, the motor 312 is coupled to the platform 102, the frame 310, or both with at least one fastener.

At 604, a rotational coupling 308 is attached to a motor shaft 322, the rotational coupling 308 includes a fixed portion 324 and a rotatable portion 326. For instance, the fixed portion 324 of the rotational coupling 308 includes an outer race of the rotational bearing. The rotatable portion 326 of the rotational coupling 308 includes the inner race of the rotational bearing. A ball bearing 328 reduces friction between the rotatable portion 326 and the fixed portion 324. The rotational coupling 308 is attached to the motor shaft 322 by at least one or more of a fastener, press fit, weld, adhesive, or by at least one transmission coupling 106 including, but not limited to, electrical lines, hydraulic lines, mechanical linkages, gears, chains or the like. The material of the rotational coupling 308 includes, but is not limited to, steel, brass, aluminum, polymer, composite, ceramic, or the like.

A person of ordinary skill in the art will appreciate that the motor 312 can include, but is not limited to, an electrical motor, hydraulic motor, or internal combustion engine. The motor 312 includes a motor shaft 322 that rotates in response to a command received from the controller 314.

At 606, the fixed portion 324 of the rotational coupling 308 is coupled to the mower platform 102. In one example, the frame 310 is coupled to the platform 102 with at least one fastener 214 and the fixed portion 324 of the rotatable coupling 308 is coupled to the frame 310 by one or more of a fastener, weld, adhesive, press-fit, or the like.

At 608, the method 600 includes forming a shaft 306 configured to engage with the rotatable portion 326 of the rotational coupling 308, the shaft 306 configured to rotate with the rotatable coupling 308. In one example, the shaft 306 includes splines 502 located along the length of the shaft 306, the rotational coupling 308 is configured to engage with the splines 502 so the shaft 306 rotates along with the rotational coupling 308, and the rotational coupling 308 is positioned along the shaft 306 at a first location 332, second location 334, or any location therebetween.

The rotational coupling 308 is sized and shaped to receive the shaft 306. In one example, the rotational coupling 308 includes a cylinder shape, such as a socket, with an open socket end 338 and a closed socket end 336. The fixed portion 324 of the rotatable coupling 308 is coupled to the frame 310 by one or more of a fastener, weld, adhesive, press-fit, or the like. The rotatable portion 326 is coupled to the motor shaft 322 by one or more of the same means. The material of the rotational coupling 308, the shaft 306, or both includes, but is not limited to, steel, brass, aluminum, polymer, composite, ceramic, or other material.

The rotational coupling 308 includes an engagement feature configured to rotate the shaft 306. For instance, engagement feature includes at least one lug 504 located on the inside (e.g., inside diameter) of the rotational coupling 308. The shaft 306 includes at least one spline 502 (e.g., grooves, channels, ribs, or the like) along the length of the shaft 306. The at least one lug 504 of the rotational coupling 308 engages with the at least one spline 502 of the shaft 306 such that the rotational coupling 308 is configured to transfer torque to the shaft 306. In one example, rotation of the motor shaft 322 results in rotation of the rotational coupling 308 and in turn the shaft 306.

At 610, the method 600 includes fabricating the shaft 306 to translate axially from a first location 332 to a second location 334 with respect to the rotational coupling 308. In one example, the rotational coupling 308 is configured to translate with respect to the shaft 306. For instance, the rotational coupling 308 is operationally coupled at the first shaft end 332, the second shaft end 334, or at any location therebetween. Stated another way, the one or more lugs 504 of the rotational coupling 308 engage with the one or more splines 502 along the length of the shaft 306. The lugs 504 translate along the shaft 306 at any location from the first shaft end 332, second shaft end 334, or a location therebetween. In one example, the spline 502 is formed by cutting a channel along the length of the shaft 306 with a milling bit. The lug 504, for example, is formed by removing material form the rotational coupling 308 with an electrode or by removing material by machining

At 612, a mower disk 124 is provided and configured to attach to the shaft 306, wherein the mower disk 124 is configured to rotate and translate with the shaft 306. In one example, a lower disk bracket 316 rotationally couples the second shaft end 334 to the lower disk 304 with at least one fastener. For instance, the lower disk bracket 316 includes a bracket bearing 317 (e.g., a wheel bearing) such that the bracket bearing 317 couples the lower disk 304 to the shaft 306 and the lower disk 304 is free to rotate with respect to the shaft 306.

In one example, a blade 122 is coupled to the mower disk 124. The blade 122 includes a base and a distal end. The distal end includes a cutting edge. The base portion is coupled to the shaft 306 and the distal portion of the blade 122 is positioned outwardly from the center axis of the shaft 306. In one example, the base of the blade 122 coupled to the shaft 306 with a fastener, a weld, an adhesive, or the like. In one example, the blade 122 is rotatably coupled to the disk 124. The blade 122 is aligned in a position extended outwardly from the shaft 306 by centrifugal force. The stress on the blade 122 is mitigated by the rotatable blade coupling, such as if the blade 122 collides with an object (e.g., a rock), the blade 122 pivots out of the way of the obstruction.

In one example, the method 600 includes providing a follower plate 210 located on the mower disk 124 and configuring the shaft 306 to translate axially in response to force applied to the follower plate 210. In one example, the follower plate 210 is included in the mower disk 124. For instance, the follower plate 210 is coupled to the bottom of the mower disk 124 (e.g., lower disk 302) with one or more fasteners. The follower plate 210 engages with the landscape 212. The material of the follower plate 210 includes, but is not limited to, steel, aluminum, polymer, composite, or other materials. In one example, the material of the follower plate 210 includes a low friction material (e.g., Polyoxymethylene) that minimizes friction resulting from engagement between the disk 124 and the landscape 212. The follower plate 210 is easily and inexpensively replaced if damaged. For instance, removal of one or more fasteners decouples the follower plate 210 from the disk 124. A new follower plate 210 can be attached to the disk 124 with one or more fasteners. In one example, the follower plate 210 includes an inexpensive material and fabrication. In one example, the follower plate 210 is coupled to the shaft 306, such as at the end of the shaft 306 (e.g., second shaft end 334).

The method 600 can also include providing a shield 204 with one or more segments (e.g., small shield segment 208 or large shield segment 206). At least one shield segment is coupled to the mower disk 124. Each segment is positioned around the shaft 306 and configured to translate with respect to another segment (e.g., the small segment 208 translates with respect to the large shield segment 206) such that the length of the shield 204 is adjustable to the position of the mower disk 124.

In one example, the method 600 includes including the motor 312, rotatable coupling 308, shaft 306, and mower disk 124 in a mowing module 120 configured for coupling to the mower platform 102 with one or more fasteners 214. In one example, the module 120 is coupled to the platform 102 with a mount 202. As previously described, one or more fasteners 214 attach the mount 202 to the platform 202. In one example, the mount 202 is included in the frame 310, such as the mount 202 and the frame 310 are included in one component. In one example, the mount 202 and the frame 310 are individual components and the mount 202 is coupled to the frame 310 with at least one fastener.

In one example, each module 120 includes a motor 312. In another example, the module 120 can be powered by a shared power source (e.g., motor), such as a power-take-off (PTO) of the agricultural vehicle 110, an electrical motor, hydraulic motor, or internal combustion engine operationally coupled to each of the modules 120. Depending on the type of motor 312, each of the one or more modules 120 can be coupled to the motor 312 by at least one transmission coupling 106 including, but not limited to, electrical lines, hydraulic lines, mechanical linkages, gears, chains or the like. The motor 312 rotates the blade 122 by way of the rotational coupling 308 and the shaft 306. The motor 312 provides sufficient kinetic energy to cut the trimming subject with the blade 122. In one example, the shared motor can be included in the mowing apparatus 100 and coupled to the mower platform 102.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions (e.g., commands) for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A mowing apparatus comprising:
a mower platform;
a rotational coupling configured to couple to a motor, wherein the rotational coupling includes a fixed portion and a rotatable portion, and the fixed portion of the rotational coupling is attached to the mower platform;
a shaft operably coupled to the rotatable portion of the rotational coupling, wherein the rotational coupling is configured to rotate the shaft, and the shaft is configured to translate axially from a first location to a second location with respect to the rotational coupling; and
a blade coupled to the shaft and positioned outwardly from the shaft, wherein the blade includes a cutting edge.

2. The mowing apparatus of claim 1, further comprising a mower disk including an upper portion and a lower portion, the blade coupled to the mower disk and the lower portion angled between the center and the periphery towards the mower platform.

3. The mowing apparatus of claim 2, further comprising a follower plate located on the mower disk, whereby the shaft translates axially in response to force applied to the follower plate.

4. The mowing apparatus of claim 1, further comprising a shield including one or more segments coupled to the mowing apparatus, the one or more segments of the shield positioned around the shaft and each segment configured to translate with respect to another segment such that the length of the shield is adjustable to the position of the blade.

5. The mowing apparatus of claim 1, wherein the mower platform includes at least one ground engaging wheel.

6. The mowing apparatus of claim 1, wherein the shaft includes splines located along the length of the shaft, the rotational coupling is configured to engage with the splines so the shaft rotates along with the rotational coupling, and the rotational coupling is positioned along the shaft at a first location, second location, or any location therebetween.

7. The mowing apparatus of claim 1, wherein the motor is coupled to the mower platform, the motor being an electric motor, hydraulic motor, internal combustion engine, or other type of motor.

8. The mowing apparatus of claim 7, wherein the motor, rotatable coupling, shaft, and blade are included in a modular assembly configured for coupling to the mower platform with one or more fasteners.

9. The mowing apparatus of claim 7, wherein the mowing apparatus further comprises a plurality of motors, each coupled to a dedicated shaft and blade.

10. The mowing apparatus of claim 1, wherein the rotatable portion of the rotational coupling further comprises lugs that engage with the splines of the shaft.

11. The mowing apparatus of claim 1, wherein the mower platform is configured to couple to an agricultural vehicle.

12. A method comprising:
fabricating a mower platform;
attaching a rotational coupling a motor shaft, the rotational coupling including a fixed portion and a rotatable portion;
coupling the fixed portion of the rotational coupling to the mower platform;
forming a shaft configured to engage with the rotatable portion of the rotational coupling, the shaft configured to rotate with the rotatable coupling;
fabricating the shaft to translate axially from a first location to a second location with respect to the rotational coupling; and
providing a mower disk configured to attach to the shaft, wherein the mower disk is configured to rotate and translate with the shaft.

13. The method of claim 12, further comprising coupling a blade to the mower disk.

14. The method of claim 12, further comprising providing a follower plate located on the mower disk and configuring the shaft to translate axially in response to force applied to the follower plate.

15. The method of claim 12, further comprising providing a shield including one or more segments, at least one segment coupled to the mower disk, each segment positioned around the shaft and configured to translate with respect to another segment such that the length of the shield is adjustable to the position of the mower disk.

16. The method of claim 12, further comprising coupling at least one ground engaging wheel to the mower platform.

17. The method of claim 12, further comprising forming the shaft to include splines located along the length of the shaft, the rotational coupling is configured to engage with the splines so the shaft rotates along with the rotational coupling, and the rotational coupling is positioned along the shaft at a first location, second location, or any location therebetween.

18. The method of claim 12, further comprising coupling the motor to the mower platform.

19. The method of claim 18, further comprising including the motor, rotatable coupling, shaft, and mower disk in a mowing module configured for coupling to the mower platform with one or more fasteners.

20. The method of claim 18, further comprising providing a plurality of motors, each coupled to a dedicated mower disk.

21. The method of claim 12, further comprising forming lugs and the rotatable portion of the rotational coupling, the lugs configured to engage with the splines of the shaft.

22. A mowing module comprising:
a module mount configured to couple to a mower platform with at least one fastener;
a rotational coupling including a fixed portion and a rotating portion, the fixed portion is coupled to the module mount;
a motor operationally coupled to the rotating portion of the rotational coupling;
a shaft operably coupled to a rotatable portion of the rotational coupling, wherein the rotational coupling is configured to rotate the shaft, and the shaft is configured to translate axially from a first location to a second location with respect to the rotational coupling; and
a mower disk including at least one blade coupled thereto, the mower disk operably coupled to the shaft.

23. The mowing module of claim 22, wherein the mower disk includes an upper portion and a lower portion, the lower portion angled towards the mower platform between the center and the periphery of the lower portion.

24. The mowing module of claim 22, further comprising a follower plate located on the mower disk, whereby the shaft translates axially in response to force applied to the follower plate.

25. The mowing module of claim 22, further comprising a shield including one or more segments coupled to the mowing module, the one or more segments of the shield positioned around the shaft and each segment configured to translate with respect to another segment such that the shield length is adjustable to the position of the mower disk.

26. The mowing module of claim 22, wherein the mower platform includes at least one ground engaging wheel.

27. The mowing module of claim 22, wherein the shaft includes splines located along the length of the shaft, the rotational coupling is configured to engage with the splines so the shaft rotates along with the rotational coupling, and the rotational coupling is positioned along the shaft at a first location, second location, or any location therebetween.

28. The mowing module of claim 22, wherein the motor is an electric motor, hydraulic motor, internal combustion engine, or other type of motor.

29. The mowing module of claim 22, wherein the rotatable portion of the rotational coupling further comprises lugs that engage with the splines of the shaft.

30. The mowing module of claim 22, wherein the mower platform is configured to couple to an agricultural vehicle.
